(19) United States
(12) Patent Application Publication
(10) Pub. No.: US 2006/0193682 A1
(43) Pub. Date: Aug. 31, 2006

(54) Non-metal joint structure for a bicycle seat post

(76) Inventor: A. P. Lin, Changhwa City (TW)

Correspondence Address: CHARLES E. BAXLEY, ESQ., 90 JOHN STREET, THIRD FLOOR, NEW YORK, NY, 10038, US

(21) Appl. No.: 11/068,023

(22) Filed: Feb. 28, 2005

(51) Int. Cl. F16B 9/00

(52) U.S. Cl. 403/192

(57) ABSTRACT

The present invention relates to a non-metal joint structure for a bicycle seat post comprising a fixing seat for retaining a bicycle seat, beneath the fixing seat formed a connecting portion for insertion into the seat post, and an axial through hole formed in the fixing seat; wherein the fixing seat of the joint structure is integrally formed with the connecting portion by means of molding, the fixing seat and the connecting portion are made of non-metal composite material. The weight of the joint structure of the present invention can be reduced effectively, and the defect of inconsistency in appearance of the conventional joint structure can be eliminated.

### BACKGROUND OF THE INVENTION

1. Field of the Invention

The present invention relates to a non-metal joint structure for a bicycle seat post, and more particularly to non-metal joint structure that is fixed on a bicycle seat post for holding the bicycle seat.

2. Description of the Prior Arts

Referring to FIG. 1, a conventional joint structure 11 for a bicycle seat post is usually fixed at the top end of the carbon fiber seat post 10, at an end surface of the joint structure 11 is integrally formed a fixing seat 12 for retaining a bicycle seat (not shown). Beneath the fixing seat 12 is integrally formed a connecting portion 13 for connecting to the carbon fiber seat post 10 by means of screws or glue.

The above-mentioned joint structure 11 is a unitary structure generally made of metal or alloy material, at the top end of the fixing seat 12 of the joint structure 11 is formed an arc-shaped surface 14, on which are arranged a plurality of parallel ribs 15. Besides, an axial through hole 16 is formed on the fixing seat 12. By such an arrangement, on the arc-shaped surface 14 of the fixing seat 12 and in the through hole 16 can be provided adjustable fixing members so as to fix the bicycle seat adjustably. However, this conventional joint structure 11 for a seat post still has some disadvantages that are explained as follows:

First, the joint structure 11 is heavy since it is made of alloy or metal material, relatively increasing the weight of the bicycle.

Second, since the fiber material seat tube and the alloy joint structure are made of different materials, this will cause inconsistency in appearance.

The present invention has arisen to mitigate and/or obviate the afore-described disadvantages.

### SUMMARY OF THE INVENTION

The primary objective of the present invention is to provide a non-metal joint structure for a bicycle seat post comprising a fixing seat for retaining a bicycle seat, beneath the fixing seat formed a connecting portion for insertion into the seat post, and an axial through hole formed in the fixing seat; wherein the fixing seat of the joint structure is integrally formed with the connecting portion by means of molding, the fixing seat and the connecting portion are made of non-metal composite material. The weight of the joint structure of the present invention can be reduced effectively, and the defect of inconsistency in appearance of the conventional joint structure can be overcome.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a conventional joint structure for a bicycle seat post;

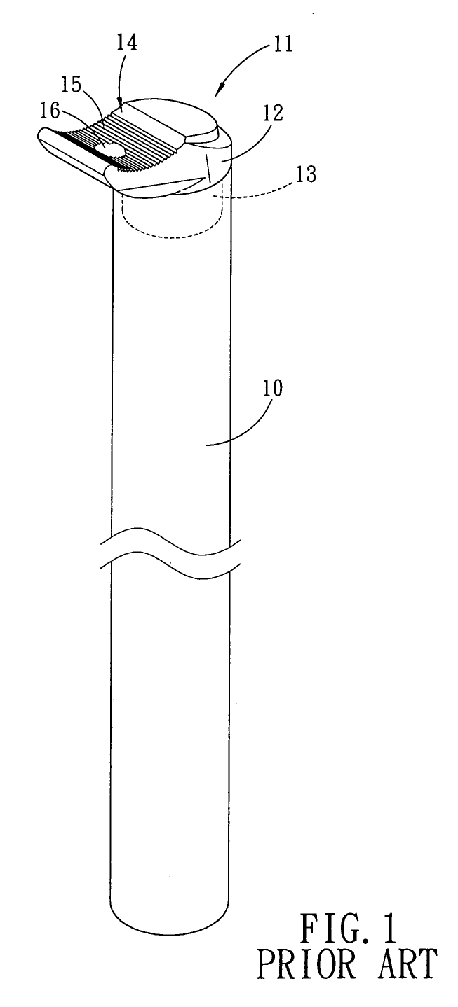

FIG. 2 is an assembly view of a joint structure for a bicycle seat post in accordance with the present invention;

FIG. 3 is an exploded view of the joint structure for a bicycle seat post in accordance with the present invention;

FIG. 4 is an operational view of the joint structure for a bicycle seat post in accordance with the present invention;

FIG. 5 showing the joint structure for a bicycle seat post being assembled with fixing member;

FIG. 6 a cross sectional view of a joint structure for a bicycle seat post in accordance with a second embodiment of the present invention.

### DETAILED DESCRIPTION OF THE PREFERRED EMBODIMENTS

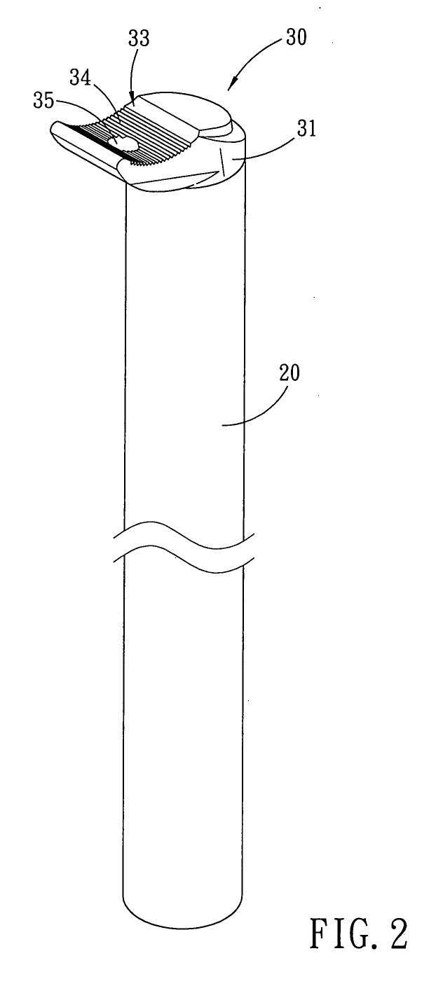

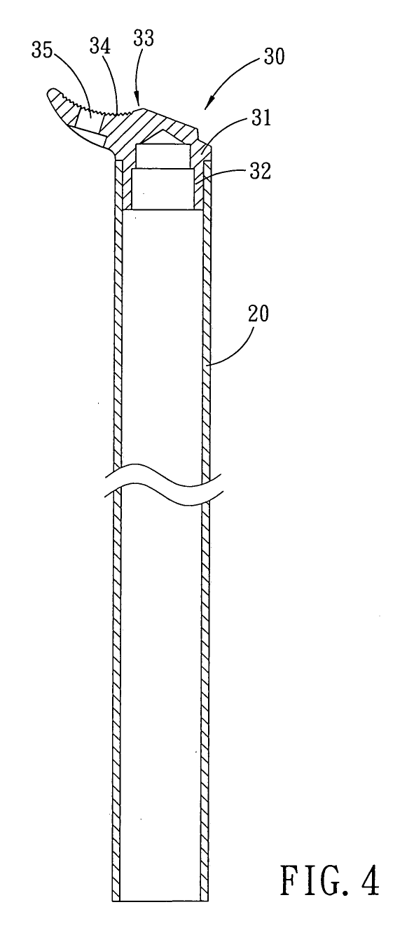

Referring to FIGS. 2-5, in which, a non-metal joint structure 30 for a bicycle seat post 20 in accordance with a preferred embodiment of the present invention is shown, and on the joint structure 30 is provided an adjustable fixing member 40.

The seat post 20 is a hollow tube made of carbon fiber and the like composite materials.

The joint structure 30 is made of non-metal composite material and integrally formed by ejection molding or compression molding. On the joint structure 30 is formed a fixing seat 31 for holding the bicycle seat, beneath the fixing seat 31 is connecting portion 32 for insertion into the seat post 20. On a top end of the fixing seat 31 is an arc-shaped surface 33, on which are formed a plurality of parallel ribs 34. An axial through hole 35 is formed on the fixing seat 31 for insertion of the adjustable fixing member 40. A lower half of the fixing seat 31 and the connecting portion 32 are formed in the shape of a hollow cylinder. The above-mentioned non-metal composite material can be composed of Nylon and glass fiber, or composed of Nylon and carbon fiber, or can be other composite materials, such as carbon fiber composite material. The methods of integrally forming the non-metal joint structure 30 include the application of compression molding (the non-metal material is integrally formed in the mold at a high pressure and temperature), or the application of ejection forming.

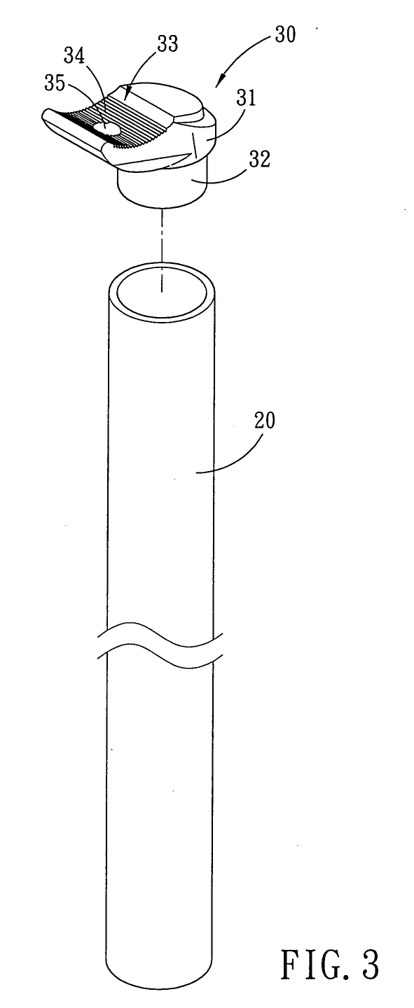

For a better understanding of the present invention, its operation and function, references should be made particularly to FIGS. 3-5, in which, the joint structure 30 in accordance with the present invention is a unitary structure made of non-metal composite material and comprises the fixing seat 31 and the connecting portion 32, the connecting portion 32 is inserted in the top end of the seat tube 20, thus creating a non-metal seat post assembly.

The joint structure 30 is a unitary structure made of non-metal composite material and comprises the fixing seat 31 and the connecting portion 32, on the top end of the fixing seat 31 is the arc-shaped surface 33, on which are formed a plurality of parallel ribs 34. Besides, the axial through hole 35 is formed on the fixing seat 31 for insertion of the adjustable fixing member 40. The lower half of the fixing seat 31 and the connecting portion 32 are formed in the shape of a hollow cylinder. Such arrangements help to reduce the material waste, save the production cost, and decrease the weight of the joint structure 30 effectively.

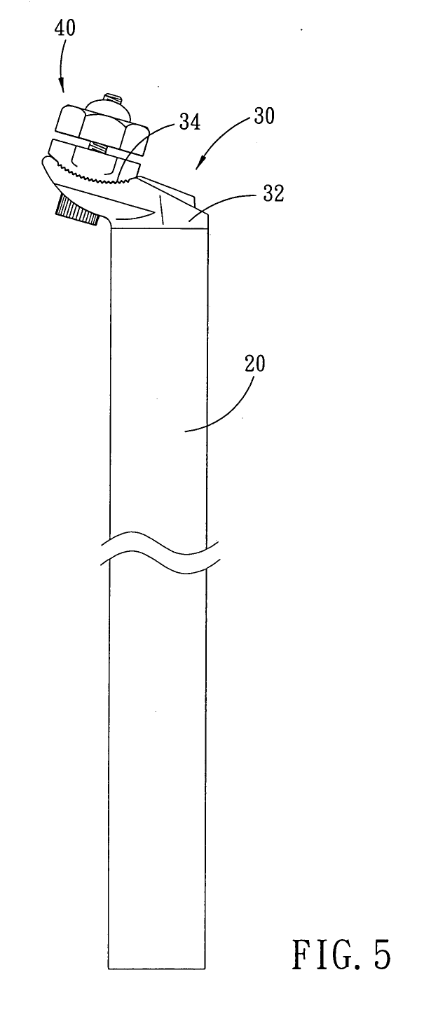

During the riding of the bicycle, due to the downward pressure caused by weight of the rider, plus the vibrations caused by rough road, an indirect stress will be produced at the junction between the ribs 34 of the joint structure 30 and the adjustable fixing member 40 (as shown in FIG. 5). Besides, the joint structure 30 is made of non-metal material, these factors will probably result in some bad consequences after a certain period of use, for example, the ribs 34 are likely to wear out and the joint structure 30 will probably be broken.

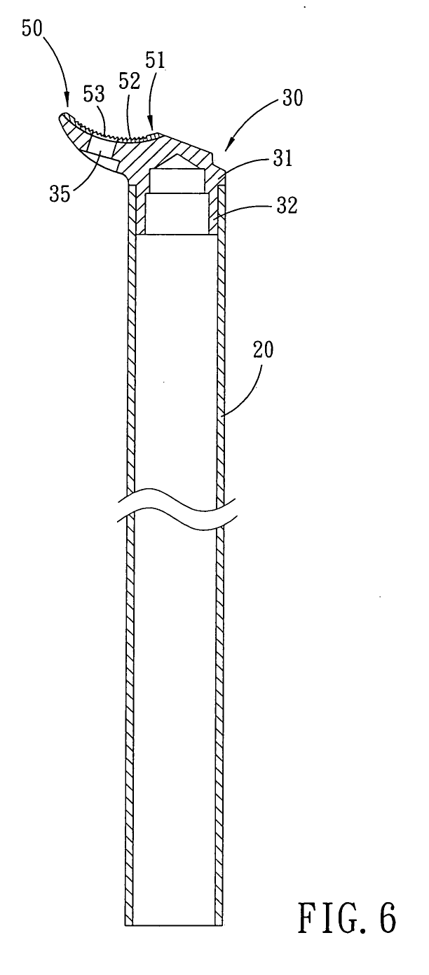

To improve the above-mentioned defects of the non-metal joint structure, it is necessary to improve the joint strength between the joint structure and the adjustable fixing member by inlaying a metal in the top surface of the joint structure, with reference to FIG. 6, a non-metal joint structure for a bicycle seat post in accordance with a second embodiment of the present invention is shown, which is similar with the first embodiment of the present invention, except the following differences:

A preformed inlaid metal 50 is integrally formed in the top surface of the non-metal joint structure 30 by means of ejection molding or compression molding.

The inlaid metal 50 is an arc-shaped unitary metal plate having an arc-shaped top surface 51, a plurality of parallel ribs 52 are formed on the arc-shaped top surface 51, and a through hole 53 is formed on inlaid metal 50 and located in alignment with the through hole 35 of the fixing seat 31, so that the adjustable fixing member 40 can be assembled in the fixing seat 31 and the inlaid metal 50 (FIG. 6 doesn't show the adjustable fixing member 40, reference can be made to FIG. 5). This method of inlaying the metal 50 in the top surface of the joint structure 30 can truly improve the joint strength between the joint structure 30 and the adjustable fixing member 40, so that the joint structure 30 will be more wearable and the service life of it will be prolonged.

The non-metal made joint structure for a bicycle seat post is integrally formed by non-metal composite material or formed by inlaying the metal 50 in the top surface of the joint structure, besides, the associated seat post 20 is also made of non-metal material. Therefore, the weight of the joint structure of the present invention can be reduced effectively, and the defect of inconsistency in appearance of the conventional joint structure can be overcome.

While we have shown and described various embodiments in accordance with the present invention, it should be clear to those skilled in the art that further embodiments may be made without departing from the scope of the present invention.

What is claimed is:

1. A non-metal joint structure for a bicycle seat post comprising a fixing seat for retaining a bicycle seat, beneath the fixing seat formed a connecting portion for insertion into the seat post, and an axial through hole formed in the fixing seat; wherein
the fixing seat of the joint structure is integrally formed with the connecting portion by means of molding, the fixing seat and the connecting portion are made of non-metal composite material.

2. The non-metal joint structure for a bicycle seat post as claimed in claim 1, wherein a metal is inlaid in a top surface of the non-metal joint structure by means of molding.

3. The non-metal joint structure for a bicycle seat post as claimed in claim 1, wherein the non-metal composite material is composed of Nylon and glass fiber.

4. The non-metal joint structure for a bicycle seat post as claimed in claim 2, wherein the non-metal composite material is composed of Nylon and glass fiber.

5. The non-metal joint structure for a bicycle seat post as claimed in claim 1, wherein the non-metal composite material is composed of Nylon and carbon fiber.

6. The non-metal joint structure for a bicycle seat post as claimed in claim 2, wherein the non-metal composite material is composed of Nylon and carbon fiber.

7. The non-metal joint structure for a bicycle seat post as claimed in claim 3, wherein the non-metal joint structure is formed by ejection molding.

8. The non-metal joint structure for a bicycle seat post as claimed in claim 4, wherein the non-metal joint structure is formed by ejection molding.

9. The non-metal joint structure for a bicycle seat post as claimed in claim 1, wherein the non-metal composite material is carbon fiber.

10. The non-metal joint structure for a bicycle seat post as claimed in claim 2, wherein the non-metal composite material is carbon fiber.

11. The non-metal joint structure for a bicycle seat post as claimed in claim 7, wherein the non-metal joint structure is made of carbon fiber that is integrally formed in mold at a high pressure and temperature.

12. The non-metal joint structure for a bicycle seat post as claimed in claim 2, wherein the metal is an arc-shaped unitary metal plate having an arc-shaped top surface, a plurality of parallel ribs are formed on the arc-shaped top surface, and a through hole is formed on inlaid metal and located in alignment with the through hole of the fixing seat.

13. The non-metal joint structure for a bicycle seat post as claimed in claim 1, wherein a lower half of the fixing seat and the connecting portion are formed in the shape of a hollow cylinder.

14. The non-metal joint structure for a bicycle seat post as claimed in claim 2, wherein a lower half of the fixing seat and the connecting portion are formed in the shape of a hollow cylinder.
